(19) United States
(12) Patent Application Publication
(10) Pub. No.: US 2025/0219113 A1
(43) Pub. Date: Jul. 3, 2025

(54) A METAL-FEEDING METHOD FOR METAL-AIR FUEL CELLS

(71) Applicant: National University of Singapore, Singapore (SG)

(72) Inventors: Qing Wang, Singapore (SG); Hang Zhang, Singapore (SG); Yuxi Song, Singapore (SG)

(73) Assignee: National University of Singapore, Singapore (SG)

(21) Appl. No.: 18/852,282

(22) PCT Filed: Mar. 28, 2023
(86) PCT No.: PCT/SG2023/050201

§ 371 Date: Sep. 27, 2024

(30) Foreign Application Priority Data
Mar. 28, 2022 (SG) 10202203136Y

(51) Int. Cl. H01M 8/04082; H01M 8/18

(52) U.S. Cl. CPC H01M 8/04208; H01M 8/188

(57) ABSTRACT

Disclosed herein are a metal-air fuel cell metal source material, a composite material comprising a metal selected from an alkali metal, an alkaline earth metal, aluminium, zinc, or iron, a conductive carbon material, and a binder, a redox-mediated metal-air fuel cell cartridge comprising a cartridge housing, and a composite material comprising a metal selected from an alkali metal, an alkaline earth metal, aluminium, zinc, or iron, a conductive carbon material, and a binder, and a redox-mediated metal-air fuel cell system comprising a redox flow cell and a first tank suitable to house an anolyte and a redox-mediated metal-air fuel cell cartridge. Also disclosed herein is a method of feeding a metal in a redox-mediated metal-air fuel cell system.

### FIELD OF INVENTION

The present invention relates to metal-air fuel cells and a method of feeding a metal in a redox-mediated metal-air fuel cell system for recharging the metal-air fuel cell system.

### BACKGROUND

The listing or discussion of a prior-published document in this specification should not necessarily be taken as an acknowledgement that the document is part of the state of the art or is common general knowledge.

A flow battery is alike to an electrochemical cell except the electrolyte is not stored in the cell around the electrodes. Instead, the ionic solution is stored outside of the cell, and can be fed into the cell in order to generate electricity.

Zinc-based flow batteries have drawn considerable attention due to low material cost, high cell voltage, earth abundance and low toxicity. However, traditional mechanically rechargeable zinc-air batteries have relatively difficult ‘refuelling’ process and face electrode passivation issues.

Therefore, there exists a need for new rechargeable redox-mediated metal-air fuel cell systems that are endowed with ultrahigh energy density, outstanding operation flexibility, good scalability, low cost, and excellent safety for various energy storage applications, and can overcome at least one of the aforementioned problems.

### SUMMARY OF INVENTION

Aspects and embodiments of the current invention that address the above problems are provided in the following numbered clauses.

1. A redox-mediated metal-air fuel cell system, comprising:
a redox flow cell comprising:
   a cathode compartment, comprising one of:
      a cathode electrode, and an inlet and outlet suitable for bubbling gas through the cathode compartment;
      or a gas diffusion air electrode for oxygen reduction reaction (ORR) supplied with air through the cathode compartment;
an anode compartment, comprising an anode electrode, and an inlet and outlet suitable for receiving and providing an anolyte to a first tank;
an ion-selective membrane between the cathode compartment and the anode compartment; and
a first tank suitable to house an anolyte and a redox-mediated metal-air fuel cell cartridge and an inlet and outlet suitable for receiving and providing an anolyte to the anode compartment, wherein:
the redox-mediated metal-air fuel cell cartridge, comprises:
   a cartridge housing; and
   a composite material, comprising:
   a metal selected from an alkali metal, an alkaline earth metal, aluminium, zinc, or iron;
   a conductive carbon material; and
   a binder.

2. The system according to claim 1, wherein the metal is selected from one or more of the group selected from Zn, Li, Na, K, Mg, Ca, Al, and Fe.

3. The system according to Clause 2, wherein the metal is Zn.

4. The system according to any one of the preceding clauses, wherein the binder is selected from one or more of ethylene cellulose, polyolefin, and a fluorine-containing thermoplastic, optionally wherein the fluorine-containing thermoplastic is selected from one or more of the group selected from PTFE and PVDF.

5. The system according to Clause 4, wherein the binder is PVDF.

6. The system according to any one of the preceding clauses, wherein:
the metal is present in an amount of from 50 to 95 wt %;
the conductive carbon material is present in an amount of from 2.5 to 30 wt %;
the binder is present in an amount of from 2.5 to 20 wt %.

7. The system according to Clause 6, wherein:
the metal is present in an amount of from 80 to 92 wt %, such as about 90 wt %;
the conductive carbon material is present in an amount of from 3 to 10 wt %, such as about 5 wt %;
the binder is present in an amount of from about 3 to 10 wt %, such as about 5 wt %.

8. The system according to any one of the preceding clauses, wherein the metal source material is provided in particulate form.

9. The system according to any one of the preceding clauses, wherein the conductive carbon material is a carbon black.

10. The system according to any one of the preceding clauses, wherein the anode compartment and the first tank further comprise an anolyte comprising an anodic redox mediator and an electrolyte.

11. The system according to Clause 10, wherein:
(a) the anodic redox mediator is selected from one or more of the group consisting of a phenazine derivative, an anthraquinone derivative, and an alloxazine derivative, optionally wherein the anodic redox mediator is 7,8-dihydroxy-2-phenazinesulfonic acid; and/or
(b) the anodic redox mediator has a concentration of from 0.01 to 2 M, such as about 0.4 M; and/or
(c) the electrolyte is selected from one or more of aqueous NaOH, aqueous KOH (e.g. the concentration of the KOH in water is 3 M), and aqueous LiOH (e.g. the concentration of the LiOH in water is 3 M), optionally wherein the concentration of the NaOH in water is 3 M.

12. The system according to Clause 10 or Clause 11, wherein when the cathode compartment comprises a cathode electrode, and an inlet and outlet suitable for bubbling gas through the cathode compartment, it further comprises a catholyte comprising a cathodic redox mediator and an electrolyte.

13. The system according to Clause 12, wherein:
(a) the cathodic redox mediator is selected from one or more of the group consisting of Co(III)TiPA, cobalt triethanolamine complex [Co(TEA)] and anthraquinone-2,6-disulfonate (AQDS); and/or
(b) the cathodic redox mediator has a concentration of from 0.01 to 1 M, such as about 0.2 M; and/or
(c) the electrolyte is selected from one or more of aqueous NaOH, aqueous KOH (e.g. the concentration of the KOH in water is 3 M), and aqueous LiOH (e.g. the concentration of the LiOH in water is 3 M), optionally wherein the concentration of the NaOH in water is 3 M.

14. The system according to any one of the preceding clauses, wherein when the cathode compartment comprises a cathode electrode, and an inlet and outlet suitable for bubbling gas through the cathode compartment, the cathode compartment comprises:
a cathode housing section;
a cathode housed within the cathode housing section; and
a second tank suitable to house a catholyte, an inlet and outlet suitable for receiving and providing a catholyte to the cathode housing section, and an inlet and outlet suitable for bubbling gas through the second tank.

15. The system according to any one of Clauses 1 to 10, wherein, when the cathode compartment comprises a gas diffusion electrode, then the cathodic air electrode is selected from a porous carbon material that is coated with an oxygen reduction reaction catalyst, optionally wherein the oxygen reduction catalyst is selected from one or more of the group selected from platinum group metals (platinum or palladium), non-platinum-group noble metals (e.g. gold, silver), a carbon-based catalyst (e.g. a NiCo catalyst with N-doped carbon nanotubes as support, a porous carbon decorated with dispersed Fe—Nₓ species and B-centres).

16. A redox-mediated metal-air fuel cell cartridge, comprising:
a cartridge housing; and
a composite material, comprising:
a metal selected from an alkali metal, an alkaline earth metal, aluminium, zinc, or iron;
a conductive carbon material; and
a binder.

17. The cartridge according to Clause 16, wherein the metal is selected from one or more of the group selected from Zn, Li, Na, K, Mg, Ca, Al, and Fe.

18. The cartridge according to Clause 17, wherein the metal is Zn.

19. The cartridge according to any one of Clauses 16 to 18, wherein the binder is selected from one or more of ethylene cellulose, polyolefin, and a fluorine-containing thermoplastic, optionally wherein the fluorine-containing thermoplastic is selected from one or more of the group selected from PTFE and PVDF.

20. The cartridge according to Clause 19, wherein the binder is PVDF.

21. The cartridge according to any one of Clauses 16 to 20, wherein:
the metal is present in an amount of from 50 to 95 wt %;
the conductive carbon material is present in an amount of from 2.5 to 30 wt %;
the binder is present in an amount of from 2.5 to 20 wt %.

22. The cartridge according to Clause 21, wherein:
the metal is present in an amount of from 80 to 92 wt %, such as about 90 wt %;
the conductive carbon material is present in an amount of from 3 to 10 wt %, such as about 5 wt %;
the binder is present in an amount of from about 3 to 10 wt %, such as about 5 wt %.

23. The cartridge according to any one of Clauses 16 to 22, wherein the metal source material is provided in particulate form.

24. The cartridge according to any one of Clauses 16 to 23, wherein the conductive carbon material is a carbon black.

25. A method of feeding a metal in a redox-mediated metal-air fuel cell system, comprising:
a redox flow cell comprising:
   a cathode compartment, comprising one of:
      a cathode electrode, and an inlet and outlet suitable for bubbling gas through the cathode compartment;
   an anode compartment, comprising an anode electrode, an anolyte comprising an anodic redox mediator and an electrolyte, and an inlet and outlet suitable for receiving and providing the anolyte to a first tank;
   an ion-selective membrane between the cathode compartment and the anode compartment; and
   a first tank comprising the anolyte, a redox-mediated metal-air fuel cell cartridge as described in any one of Clauses 16 to 24 and an inlet and outlet suitable for receiving and providing the anolyte to the anode compartment, wherein the method involves:
   (a) cycling the anolyte from the first tank to the anode compartment and back again, and supplying a gas to the catholyte; and
   (b) replacing the redox-mediated metal-air fuel cell cartridge when it has been exhausted.

26. The method according to Clause 25, wherein:
(a) when the cathode compartment comprises a cathode electrode, and an inlet and outlet suitable for bubbling gas through the cathode compartment, the cathodic redox mediator is selected from one or more of the group consisting of Co(III)TIPA, cobalt triethanolamine complex [Co(TEA)] and anthraquinone-2,6-disulfonate (AQDS), or;
(b) when the cathode compartment comprises a cathode electrode, and an inlet and outlet suitable for bubbling gas through the cathode compartment, the cathodic redox mediator has a concentration of from 0.01 to 1 M, such as about 0.2 M; and/or
(c) the anodic redox mediator is selected from one or more of the group consisting of a phenazine derivative, an anthraquinone derivative, and an alloxazine derivative, optionally wherein the anodic redox mediator is 7,8-dihydroxy-2-phenazinesulfonic acid; and/or
(d) the anodic redox mediator has a concentration of from 0.01 to 2 M, such as about 0.4 M; and/or
(e) the electrolyte is selected from one or more of aqueous NaOH, aqueous KOH (e.g. the concentration of the KOH in water is 3 M), and aqueous LiOH (e.g. the concentration of the LiOH in water is 3 M), optionally wherein the concentration of the NaOH in water is 3 M.

27. The method according to Clause 25 or Clause 26, wherein when the cathode compartment comprises a cathode electrode, and an inlet and outlet suitable for bubbling gas through the cathode compartment, the cathode compartment comprises:
a cathode housing section;
a cathode housed within the cathode housing section; and
a second tank suitable to house a catholyte, an inlet and outlet suitable for receiving and providing a catholyte to the cathode housing section, and an inlet and outlet suitable for bubbling gas through the second tank.

28. The method according to Clause 25, wherein:
(a) when the cathode compartment comprises a gas diffusion electrode for oxygen reduction reaction supplied with air or oxygen directly through the cathode compartment, the cathodic air electrode is selected from a porous carbon material that is coated with an oxygen reduction reaction catalyst, optionally wherein the oxygen reduction catalyst is selected from one or more of the group selected from platinum group metals (platinum or palladium), non-platinum-group noble metals (e.g. gold, silver), a carbon-based catalyst (e.g. a NiCo catalyst with N-doped carbon nanotubes as support, a porous carbon decorated with dispersed Fe—Nₓ species and B-centres); and/or
(b) the anodic redox mediator is selected from one or more of the group consisting of a phenazine derivative, an anthraquinone derivative, and an alloxazine derivative, optionally wherein the anodic redox mediator is 7,8-dihydroxy-2-phenazinesulfonic acid; and/or
(c) the anodic redox mediator has a concentration of from 0.01 to 2 M, such as about 0.4 M; and/or
(d) the electrolyte is selected from one or more of aqueous NaOH, aqueous KOH (e.g. the concentration of the KOH in water is 3 M), and aqueous LiOH (e.g. the concentration of the LiOH in water is 3 M), optionally wherein the concentration of the NaOH in water is 3 M.

29. A metal-air fuel cell metal source material, wherein the source material comprises:
a metal selected from an alkali metal, an alkaline earth metal, aluminium, zinc, or iron;
a conductive carbon material; and
a binder.

30. A composite material, comprising:
a metal selected from an alkali metal, an alkaline earth metal, aluminium, zinc, or iron;
a conductive carbon material; and
a binder.

31. The metal source material according to Clause 29 or the composite material according to Clause 28, wherein the metal is selected from one or more of the group selected from Zn, Li, Na, K, Mg, Ca, Al, and Fe.

32. The metal source material or the composite material according to Clause 31, wherein the metal is Zn.

33. The metal source material according to any one of Clauses 29, 31 and 32, or the composite material according to any one of Clauses 30 to 32, wherein the binder is selected from one or more of ethylene cellulose, a polyolefin, and a fluorine-containing thermoplastic, optionally wherein the fluorine-containing thermoplastic is selected from one or more of the group selected from polytetrafluoroethylene (PTFE) and polyvinylidene fluoride (PVDF).

34. The metal source material or the composite material according to Clause 33, wherein the binder is PVDF.

35. The metal source material according to any one of Clauses 29, and 31 to 34, or the composite material according to any one of Clauses 30 to 34, wherein:
the metal is present in an amount of from 50 to 95 wt %;
the carbon black is present in an amount of from 2.5 to 30 wt %; and
the binder is present in an amount of from 2.5 to 20 wt %.

36. The metal source material or the composite material according to Clause 35, wherein:
the metal is present in an amount of from 80 to 92 wt %, such as about 90 wt %;
the conductive carbon material is present in an amount of from 3 to 10 wt %, such as about 5 wt %; and
the binder is present in an amount of from about 3 to 10 wt %, such as about 5 wt %.

37. The metal source material according to any one of Clauses 29, and 31 to 36, or the composite material according to any one of Clauses 30 to 36, wherein the metal source material is provided in particulate form.

38. The metal source material according to any one of Clauses 29, and 31 to 37, or the composite material according to any one of Clauses 30 to 37, wherein the conductive carbon material is a carbon black.

### DRAWINGS

FIG. 1 depicts the schematic illustration of the configuration and operation of a redox-mediated Zn-air fuel cell (RM-ZAFC). In this setup, Zn is loaded in the anodic fuel tank, while O₂ is fed to the cathodic gas diffusion tank (GDT).

FIG. 2 depicts the cyclic voltammetry (CV) of 20 mM 7,8-dihydroxy-2-phenazinesulfonic acid (DHPS) and 20 mM [Zn(OH)₄]²⁻ in 3 M NaOH. Scan rate: 10 mV/s.

FIG. 3 depicts the schematic illustration of the anodic tank to which Zn granules could be refueled after discharging.

FIG. 4 depicts (a) voltage profile of RM-ZAFC single cell with 20 mL 0.2 M Co(III)TiPA/3 M NaOH (with continuous O₂ bubbling) as catholyte and 35 mL 0.4 M DHPS/3 M NaOH (loaded with Zn granules) as anolyte. Electrode area: 5 cm². Current density: 10 mA/cm². (b) Voltage profile of the cell in (a) at a current density of 100 mA/cm². After each discharge process, the cell was rested with continuous O₂ bubbling for 2 h for self-charging of catholyte, and 0.15 g Zn granules in the anodic tank was replaced with fresh ones. (c) Voltage profile of a RM-ZAFC cell upon prolonged test with 20 mL 0.2 M Co (III) TiPA/3 M NaOH (with continuous O₂ bubbling) as catholyte and 250 mL 0.2 M DHPS/3 M NaOH (loaded with Zn granules) as anolyte. Electrode area: 1 cm². After loading Zn granules, the catholyte was self-charged until the open-circuit voltage (OCV) of the cell increased to 1.05 V.

FIG. 5 depicts polarization curve and power performance of a cell with 20 mL 0.2 M Co (III) TiPA/3 M NaOH as catholyte and 35 mL 0.4 M DHPS-2H/3 M NaOH as anolyte at different state of charge (SOC). Electrode area: 1 cm².

FIG. 6 depicts scanning electron microscopic (SEM) images of the Zn granules (a) before discharging and (b) after discharging from last granule loading in FIG. 4c, and (c, d) anodic carbon felt after discharging in FIG. 5d, and X-ray diffraction (XRD) patterns of the Zn granules and anodic carbon felt (e) before and (f) after discharging in FIG. 5d.

FIG. 7 depicts the (a) configuration showing the exploded view and (b) photo of a 4-cell RM-ZAFC stack. (c) Voltage profile of the 4-cell RM-ZAFC stack with 20 mL 0.2 M Co (III) TiPA 3 M NaOH (with continuous O₂ bubbling) as catholyte and 35 mL 0.4 M DHPS 3 M NaOH (loaded with Zn granules) as anolyte. Electrode area: 1 cm². Current density: 10 mA/cm². (d) Comparison of RM-ZAFC, conventional ZAB and alkaline fuel cell in terms of energy density, cost, scalability, flexibility, power density, volumetric capacity, safety and feasibility.

FIG. 8 depicts (a) voltage profile of the 4-cell RM-ZAFC stack with 20 mL 0.2 M Co (III) TiPA/3 M NaOH bubbling O₂ continuously as catholyte and 35 mL 0.4 M DHPS/3 M NaOH loaded with Zn granules as anolyte. Electrode area: 1 cm². Current density: 100 mA/cm². After each discharging process, the cell was rested with continuous O₂ bubbling for 1.5 h for self-charge of catholyte, and Zn granules in the anodic tank were replaced with fresh ones. (b) Voltage profile of the 4-cell flow cell stack during self-charge and Zn replacement.

FIG. 9 depicts long-term discharge curve at 50 mA/cm² with 200 mL 0.5 M DHPS/6 M KOH anolyte. The cathode was supplied with 1.5 bar dry oxygen and a Pt loading of 0.4 mg/cm² was used for ORR, the working temperature is 50° C. The membrane is FAAM15 and was pre-treated in 6 M KOH for more than 24 hours.

FIG. 10 depicts a further schematic illustration of the configuration and operation of a redox-mediated Zn-air fuel cell (RM-ZAFC). In this setup, Zn is loaded in the anodic fuel tank, while O₂ is fed to the cathodic gas diffusion tank (GDT).

### DESCRIPTION

It has been surprisingly found that a redox-mediated metal-air fuel cell (RM-ZAFC) system can significantly boost the feasibility of the ‘refuelling’ process (discussed hereinbefore) compared to traditional mechanically rechargeable zinc air batteries. This RM-ZAFC may also address the electrode passivation issue confronted by conventional alkaline Zn-based batteries, significantly improves the volumetric energy density and safety compared to traditional hydrogen fuel cells, and improves an open design of the setup in RM-ZAFC and reduces the price for maintenance. These advantages may be derived from the use of a particular composite material or metal-air fuel cell metal source material, which are disclosed herein, and therefore, the disclosed invention also relates to said materials and their applications.

Thus, in a first aspect of the invention, there is provided a metal-air fuel cell metal source material, wherein the source material comprises:
a metal selected from an alkali metal, an alkaline earth metal, aluminium, zinc, or iron;
a conductive carbon material; and
a binder.

Thus, in a second aspect of the invention, there is provided a composite material, comprising:
a metal selected from an alkali metal, an alkaline earth metal, aluminium, zinc, or iron;
a conductive carbon material; and
a binder.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

As used herein, the singular forms “a,” “an,” and “the” include plural referents unless the context clearly dictates otherwise. Thus, for example, reference to “a composition” includes mixtures of two or more such compositions, reference to “a metal” includes mixtures of two or more such metals, and the like.

As mentioned herein, the metal used in the composite material and hence in the metal-air fuel cell metal source material and the composite material mentioned hereinbefore may be an alkali metal, an alkaline earth metal, aluminium, zinc, or iron. Any suitable metal may be used herein. Examples of suitable metals, includes, but are not limited to Zn, Li, Na, K, Mg, Ca, Al, Fe, and combinations thereof. In particular embodiments that may be mentioned herein, the metal may be Zn.

The binder when used herein is intended to ensure contact between the metals and the conductive carbon materials and hold said materials together in the desired form (e.g. particles and/or granules). The binder may be any suitable material for this purpose and may be a material that is inert in the conditions found within a metal-air fuel cell. Any material having the properties defined above may be used in embodiments of the invention. Examples of suitable materials includes, but is not limited to, ethylene cellulose, a polyolefin, a fluorine-containing thermoplastic and combinations thereof. In particular embodiments that may be mentioned herein, the binder may be a fluorine-containing thermoplastic. In more particular embodiments that may be mentioned herein, the binder may be selected from one or both of polytetrafluoroethylene (PTFE) and polyvinylidene fluoride (PVDF). In further embodiments that may be mentioned herein, the binder may be PVDF.

As will be appreciated, any suitable amount of metal, conductive carbon material, and binder may be used in the metal-air fuel source material and the composite material disclosed herein. For example, a suitable amount of the metal when present in the metal-air fuel source material and the composite material may be in an amount of from 50 to 95 wt %, such as from 80 to 92 wt %, such as about 90 wt %. For example, a suitable amount of the conductive carbon material when present in the metal-air fuel source material and the composite material may be in an amount of from 2.5 to 30 wt %, such as from 3 to 10 wt %, such as about 5 wt %. For example, a suitable amount of the binder when present in the metal-air fuel source material and the composite material may be in an amount of from 2.5 to 20 wt %, such as from about 3 to 10 wt %, such as about 5 wt %.

For the avoidance of doubt, it is explicitly contemplated that where a number of numerical ranges related to the same feature are cited herein, that the end points for each range are intended to be combined in any order to provide further contemplated (and implicitly disclosed) ranges. Thus, it is specifically intended that the suitable amount of the metal when present in the metal-air fuel source material and the composite material may be in an amount of:
from 50 to 80 wt %, from 50 to 90 wt %, from 50 to 92 wt %, from 50 to 95 wt %;
from 80 to 90 wt %, from 80 to 92 wt %, from 80 to 95 wt %;
from 90 to 92 wt %, from 90 to 95 wt %; and
from 92 to 95 wt %.

In yet more particular embodiments of the invention, there may be disclosed a metal source material or composite material according, where:
the metal is present in an amount of from 50 to 95 wt %;
the carbon black is present in an amount of from 2.5 to 30 wt %; and
the binder is present in an amount of from 2.5 to 20 wt %.

In yet further particular embodiments of the invention, there may be disclosed a metal source material or composite material according, where:
the metal is present in an amount of from 80 to 92 wt %, such as about 90 wt %;
the conductive carbon material is present in an amount of from 3 to 10 wt %, such as about 5 wt %; and
the binder is present in an amount of from about 3 to 10 wt %, such as about 5 wt %.

The metal-air fuel source material and the composite material disclosed herein may be provided in any suitable form. For example, these materials may be provided in a particulate form. For example, the particles may be large enough to stay within a cartridge housing (e.g. a cartridge housing suitable for use in a redox-mediated metal-air fuel cell system). For example, the particles may be in the form of granules.

Any suitable conductive carbon material may be used herein. For example, the conductive carbon material may be a carbon black, graphene, graphite, carbon nanotubes and the like, plus combinations thereof.

It has been surprisingly found that disposing a redox-mediated metal-air fuel cell cartridge within an anodic tank can continually generate electricity, provided that the cartridge is periodically replaced. Thus, in a third aspect of the invention, there is provided a redox-mediated metal-air fuel cell cartridge, comprising:
a cartridge housing; and
a composite material, comprising:
a metal selected from an alkali metal, an alkaline earth metal, aluminium, zinc, or iron;
a conductive carbon material; and
a binder.

As will be appreciated, the composite material will be housed within the cartridge housing.

The cartridge housing may be any suitable cartridge housing that can be used in a redox flow cell. Some considerations for the size of the holes in the cartridge are provided below with respect to the redox-mediated metal-air fuel cell system.

For the avoidance of doubt, the composite material may be as described hereinbefore. As such, a full description of the composite material is not included here again for the sake of brevity.

As will be appreciated, the redox-mediated metal-air fuel cell cartridge may be particularly suited for use in a redox-mediated metal-air fuel cell system. Thus, in a fourth aspect of the invention, there is provided a redox-mediated metal-air fuel cell system, comprising: a redox flow cell comprising:
a cathode compartment, comprising one of:
   a cathode electrode, and an inlet and outlet suitable for bubbling gas through the cathode compartment;
   or a gas diffusion air electrode for oxygen reduction reaction (ORR) supplied with air through the cathode compartment;
an anode compartment, comprising an anode electrode, and an inlet and outlet suitable for receiving and providing an anolyte to a first tank;
an ion-selective membrane between the cathode compartment and the anode compartment; and
a first tank suitable to house an anolyte and a redox-mediated metal-air fuel cell cartridge and an inlet and outlet suitable for receiving and providing an anolyte to the anode compartment, wherein:
the redox-mediated metal-air fuel cell cartridge, comprises:
   a cartridge housing; and
   a composite material, comprising:
   a metal selected from an alkali metal, an alkaline earth metal, aluminium, zinc, or iron;
   a conductive carbon material; and
   a binder.

For the avoidance of doubt, the redox-mediated metal-air fuel cell cartridge and the composite materials are as described hereinbefore.

As noted above, the cathode compartment may be in the form having a cathode compartment that has an inlet and outlet suitable for the bubbling of gas through the cathode compartment. Alternatively, the cathode compartment may be in the form of a gas diffusion electrode for oxygen reduction reaction supplied with air or oxygen directly through the cathode compartment. This latter arrangement may have more in common with a traditional air cathode and this may be used in place of the formerly mentioned cathode compartment in embodiments of the invention.

In certain embodiments, that may be mentioned herein, there is disclosed a redox flow cell comprising:
a cathode compartment, comprising a cathode electrode, and an inlet and outlet suitable for bubbling gas through the cathode compartment;
an anode compartment, comprising an anode electrode, and an inlet and outlet suitable for receiving and providing an anolyte to a first tank;
an ion-selective membrane between the cathode compartment and the anode compartment; and
a first tank suitable to house an anolyte and a redox-mediated metal-air fuel cell cartridge as described herein and an inlet and outlet suitable for receiving and providing an anolyte to the anode compartment.

In certain embodiments, when the cathode compartment comprises a cathode electrode, and an inlet and outlet suitable for bubbling gas through the cathode compartment, the cathode compartment comprises:
a cathode housing section;
a cathode housed within the cathode housing section; and
a second tank suitable to house a catholyte, an inlet and outlet suitable for receiving and providing a catholyte to the cathode housing section, and an inlet and outlet suitable for bubbling gas through the second tank. Thus, in more particular embodiments that may be mentioned herein, there is disclosed a redox flow cell comprising:
a cathode compartment, comprising a cathode electrode, and an inlet and outlet suitable for bubbling gas through the cathode compartment;
an anode compartment, comprising an anode electrode, and an inlet and outlet suitable for receiving and providing an anolyte to a first tank;
an ion-selective membrane between the cathode compartment and the anode compartment; and
a first tank suitable to house an anolyte and a redox-mediated metal-air fuel cell cartridge as described herein and an inlet and outlet suitable for receiving and providing an anolyte to the anode compartment, where
   the cathode compartment comprises:
a cathode housing section;
a cathode housed within the cathode housing section; and
a second tank suitable to house a catholyte, an inlet and outlet suitable for receiving and providing a catholyte to the cathode housing section, and an inlet and outlet suitable for bubbling gas through the second tank.

The redox-mediated metal-air fuel cell cartridge makes use of a cartridge housing. This housing should be porous to allow the entry and egress of a liquid (e.g. an anolyte), but the porosity should be arranged such that the composite material housed therein is not capable of escaping into the first tank in any appreciable quantities. As will be appreciated, the size of the pores or holes within the housing will be determined in great part by the size of the composite material, which may be provided in any suitable form (e.g. granules).

The composite material when used herein may be as defined above. As such, a full discussion of the possible embodiments are not included here for brevity.

Both electrodes in the redox-mediated metal-air fuel cell system, i.e., the cathode and the anode, can be a carbon, a metal, or a combination thereof. Preferably, these two electrodes have high surface area, with or without one or more catalysts, to facilitate the charge collection process. They can be made of a carbon, a metal, or a combination thereof. Examples of an electrode can be found in Skyllas-Kazacos, et al., Journal of The Electrochemical Society, 2011, 158, R55-79, and Weber, et al., Journal of Applied Electrochemistry, 2011, 41, 1137-64. The discussion above in relation to the cathode may be particularly true for a cathode electrode situated in a cathode compartment that has an inlet and outlet suitable for the bubbling of a gas through the cathode compartment, such a compartment may be suitable for the use of a liquid catholyte.

As will be appreciated, the present disclosure may be applied to any suitable metal anode that can be used in a metal-air battery system, such as anodes made using alkali metals (e.g. Li, Na, and K), alkaline earth metals (e.g. Mg and Al), and first-row transition metals (e.g. Fe and Zn) and combinations thereof.

As noted above, the cathode compartment may comprise an inlet and outlet suitable for bubbling gas through the cathode compartment. In some embodiments as mentioned herein, the gas may be oxygen.

Additionally, the anode compartment may comprise an inlet and outlet suitable for receiving and providing an anolyte to a first tank. The inlet of the anode compartment may be fluidly connected to the first tank for receiving anolyte from the first tank and the outlet of the anode compartment may be fluidly connected to the first tank for providing anolyte to the first tank. As noted above, the first tank also comprises an inlet and outlet suitable for receiving and providing an anolyte to the anode compartment. The inlet of the first tank may be fluidly connected to the anode compartment for receiving anolyte from the anode compartment and the outlet of the first tank may be fluidly connected to the anode compartment for providing anolyte to the anode compartment. As such, cycling of the anolyte from the first tank to the anode compartment and back again may be achieved.

The ion-selective membrane when mentioned herein may be an electro-active charge balancing ion conducting membrane (e.g. a potassium, lithium or sodium ion conducting membrane). The ion-selective membrane prevents cross-diffusion of the redox mediator and allows for movement of electro-active charge balancing ions (e.g. potassium, lithium ions, sodium ions, magnesium ions, aluminium ions, copper ions, protons, or a combination thereof). For example, the ion-selective membrane may be a Nafion™ membrane, a lithium phosphorus oxynitride glass, a lithium thiophosphate glass, sodium phosphorus oxynitride glass, a sodium thiophosphate glass, a NASICON-type lithium conducting glass ceramic, a NASICON-type sodium conducting glass ceramic, a Garnet-type lithium or sodium conducting glass ceramic, a ceramic nanofiltration membrane, a lithium or sodium ion-exchange membrane, or suitable combinations thereof.

In some embodiments that may be mentioned herein, the cathode compartment may further comprise a catholyte comprising a cathodic redox mediator and an electrolyte. In certain embodiments this may be stored in a second tank. In additive or alternative embodiments the anode compartment and the first tank may further comprise an anolyte comprising an anodic redox mediator and an electrolyte. As such, in certain embodiments that may be mentioned herein,
the anode compartment and the first tank may further comprise an anolyte comprising an anodic redox mediator and an electrolyte; and/or
the cathode compartment (and, when present, the second tank) may further comprise a catholyte comprising a cathodic redox mediator and an electrolyte.

A redox mediator refers to a compound present (e.g. dissolved) in the electrolyte (catholyte or anolyte) that acts as a molecular shuttle transporting charges between the respective electrodes and the energy storage materials upon charging/discharging. A redox mediator transports charges between the respective electrode and the energy storage material.

In the redox-mediated metal-air fuel cell system described herein, the catholyte may comprise any suitable cathodic redox mediator. Suitable cathodic redox mediator include, but are not limited to, Co(III)TIPA, cobalt triethanolamine complex [Co(TEA)], anthraquinone-2,6-disulfonate (AQDS), and combinations thereof. The cathodic redox mediator may be provided in any suitable concentration in the catholyte. For example, in embodiments of the invention that may be mentioned herein, the concentration of the cathodic redox mediator present in the electrolyte may be from 0.01 to 1 M, such as about 0.2 M.

In certain embodiments of the invention, the anolyte may comprise any suitable anodic redox mediator. For example, the anolyte may comprise an anodic redox mediator that includes, but is not limited to, a phenazine derivative, an anthraquinone derivative, an alloxazine derivative and combinations thereof. In particular embodiments that may be mentioned herein, the anodic redox mediator may be 7,8-dihydroxy-2-phenazinesulfonic acid. The anodic redox mediator may be provided in any suitable concentration in the anolyte. For example, in embodiments of the invention that may be mentioned herein, the concentration of the anodic redox mediator present in the electrolyte may be from 0.01 to 2 M, such as about 0.4 M.

Phenazene derivatives that may be mentioned herein include those having one or more substituents selected from —R^{a}OR³, —R^{a}SO₃H, —R^{a}COOH, —R^{a}SO₃M, —R^{a}COOM, —R^{a}N(R³)₂X, —R^{a}N(R³)₂, —R^{a}PO(OH)₂, —R^{a}SH, —R^{a}PS(OH)₂, —R^{a}—O—PO(OH)₂, —R^{a}—O—PS(OH)₂, —R^{a}—S—PS(OH)₂, or —(OCH₂CH₂)ₙOR₃, where each R³ independently is H or C1-C5 alkyl; each R^{a} independently is absent or is C₁-C₅ alkyl; M is a cation; X is an anion; and n is an integer≥1, such as disclosed in WO 2018/231926, which phenazene derivatives are hereby incorporated by reference.

Anthraquinone derivatives that may be mentioned herein may be those disclosed in WO 2012/147398, which are herein incorporated by reference.

Alloxazine derivatives that may be mentioned herein may be those disclosed in WO 2016/144909, which are herein incorporated by reference.

The electrolyte referred to above in connection to the catholyte and anolyte may comprise a solvent and one or more compounds or salts that provide ions.

A suitable solvent for use in the electrolyte is water, which may be used alone or in combination with an organic solvent suitable for use in a fuel cell system. Organic solvent can be used as additives to tune the standard potential of active materials. Suitable organic solvents that may be mentioned herein include, but are not limited to an alcohol, a carbonate, an ether, an ester, a ketone, and a nitrile.

As mentioned above, the electrolyte also comprises one or more compounds or salts that provide ions. Any suitable material may be used in this capacity. Non-limiting examples of suitable ions include, but are not limited to carboxylic acids and salts formed from complementary ions. Suitable ions that may be mentioned herein include, but are not limited to ammonium ions, lithium ions, sodium ions, potassium ions, magnesium ions, aluminium ions, copper ions, chloride ions, bromide ions, nitrate ions, and hydroxide ions (e.g. ammonium ions, lithium ions, sodium ions, potassium ions, chloride ions, optionally wherein the electrolyte is formed from one or more of the group consisting of ammonium ions, potassium ions and chloride ions (e.g. potassium ions and/or chloride ions)).

In some embodiments that may be mentioned herein, the electrolyte may be selected from one or more of aqueous NaOH, aqueous KOH (e.g. the concentration of the KOH in water is about 3 M), and aqueous LiOH (e.g. the concentration of the LiOH in water is about 3 M). For example in certain embodiments that may be mentioned herein, the electrolyte may be aqueous NaOH with a concentration in water of about 3 M.

In alternative embodiments that may be mentioned herein, the cathode compartment may comprise a gas diffusion electrode for oxygen reduction reaction supplied with air or oxygen directly through the cathode compartment. In additive embodiments the anode compartment and the first tank may further comprise an anolyte comprising an anodic redox mediator and an electrolyte. As such, in certain embodiments that may be mentioned herein,
the cathode compartment further comprises a gas diffusion electrode for oxygen reduction reaction supplied with air or oxygen directly through the cathode compartment; and the anode compartment and the first tank further comprise an anolyte comprising an anodic redox mediator and an electrolyte. The anolyte may be as described hereinbefore.

As will be appreciated, when the metal in the redox-mediated metal-air fuel cell cartridge is exhausted, the redox-mediated metal-air fuel cell cartridge in the first tank of the redox-mediated metal-air fuel cell system may be replaced to continually generate electricity. Thus, in a fifth aspect of the invention, there is provided a method of feeding a metal in a redox-mediated metal-air fuel cell system, comprising:
a redox flow cell comprising:
   a cathode compartment, comprising one of:
      a cathode electrode, and an inlet and outlet suitable for bubbling gas through the cathode compartment;
   an anode compartment, comprising an anode electrode, an anolyte comprising an anodic redox mediator and an electrolyte, and an inlet and outlet suitable for receiving and providing the anolyte to a first tank;
   an ion-selective membrane between the cathode compartment and the anode compartment; and
   a first tank comprising the anolyte, a redox-mediated metal-air fuel cell cartridge as described herein and an inlet and outlet suitable for receiving and providing the anolyte to the anode compartment, wherein the method involves:
   (a) cycling the anolyte from the first tank to the anode compartment and back again, and supplying a gas to the catholyte; and
   (b) replacing the redox-mediated metal-air fuel cell cartridge when it has been exhausted.

In certain embodiments, when the cathode compartment comprises a cathode electrode, and an inlet and outlet suitable for bubbling gas through the cathode compartment, the cathode compartment may comprise:
a cathode housing section;
a cathode housed within the cathode housing section; and
a second tank suitable to house a catholyte, an inlet and outlet suitable for receiving and providing a catholyte to the cathode housing section, and an inlet and outlet suitable for bubbling gas through the second tank.

The redox-mediated metal-air fuel cell cartridge and the various components mentioned above have been described hereinbefore already. As such, a discussion of these components is omitted here for brevity.

Advantages associated with the currently disclosed invention include:
liberation of zinc metal from the electrode to a separate “fuel” tank, making it feasible to be “refueled” after zinc metal is depleted as compared with traditional mechanically rechargeable zinc air batteries;
addressing the electrode passivation issue confronted by conventional alkaline Zn-based batteries;
presenting drastically enhanced volumetric capacity of anolyte (1,866 Ah/L, more than 30 times of vanadium flow battery, and 1.5 times of commercial 700 bar high-pressure H₂ tank);
based on metal anodes with outstanding capacity and quite low potential, which is different from other redox targeting-based electrolytes;
improves an open design of the setup in RM-ZAFC;
reduces the price for maintenance;
ultrahigh energy density;
outstanding operation flexibility;
good scalability;
low cost;
excellent safety; and
applicability in various energy storage applications.

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the claims.

Hereinafter, embodiments of the invention are illustrated in more detail with reference to the following examples. However, the present disclosure is not limited thereto. Furthermore, what is not described in this disclosure may be sufficiently understood by those who have knowledge in this field and will not be illustrated herein.

### EXAMPLES

### Materials

Polyvinylidene fluoride (PVDF) was purchased from Alfa Aesar. Zn powder (dust, particle size <63 μm, purity≥98%) was purchased from Merck. Super P conductive carbon black (TIMCAL) was used as received. The other chemicals and reagents were purchased from Sigma-Aldrich and were used without further purification. Graphite felt (6 mm in thickness) was purchased from SGL Carbon and thermally treated at 400° C. in air for 16 hours before use. Anion-exchange membrane (Sustainion X37-50 Grade T) was purchased from Dioxide Materials.

### General Procedure for the Synthesis of 0.6 M Co(II)(TiPA) Dissolved in 20 mL of 3.0 M NaOH

To synthesize 0.6 M Co(II)(TiPA) dissolved in 20 ml of 3.0 M NaOH, 4.5 g of Co(II) sulfate powder was dissolved in 10 mL of deionized water in N₂ glovebox. When Co compound was fully dissolved, 3.06 g of TiPA was added to the solution. After 10 min, 2.4 g of NaOH was dropped into the solution. As soon as NaOH was added to the solution, Co(II)(TiPA) complex began to form. The solution was then stirred for one day, and the precipitated Na₂SO₄ powder was removed by centrifugation.

### General Procedure for the Synthesis of DHPS and DHPS/3M NaOH

DHPS was synthesized using the same method as the literature. [J. Am. Chem. Soc. 2021, 143, 223-231] 0.4 M DHPS/3 M NaOH was prepared by dissolving 0.4 M DHPS in 4.2 M NaOH, considering one DHPS molecule consumes three OH during dissolution process.

### Analytical Techniques

### SEM Measurements

SEM images were collected with Zeiss Supra 40 FESEM system. Samples were loaded on conductive carbon tape and exposed to a high-energy electron beam emitted by the electrical field of 5 kV.

### XRD Measurements

XRD patterns were collected with a Bruker D8 diffractometer with Cu Kα (0.154 nm) radiation under the accelerating voltage of 40 kV at room temperature.

### Example 1. Electrochemical Measurements

CV measurements were performed using a three-electrode cell composed of a glassy carbon working electrode, a platinum plate counter electrode, and a Hg/HgO reference electrode. OCP measurements were performed using a Pine Instruments Modulated Speed Rotator AFMSRCE equipped with a 5 mm diameter glassy carbon working electrode, a Hg/HgO reference electrode, and a platinum plate counter electrode. Rotating rate: 1000 rpm. All electrochemical tests were conducted with an Autolab electrochemical workstation (Metrohm, PSTA30).

### Example 2. Redox Mediated Zn-Air Fuel Cell (RM-ZAFC)

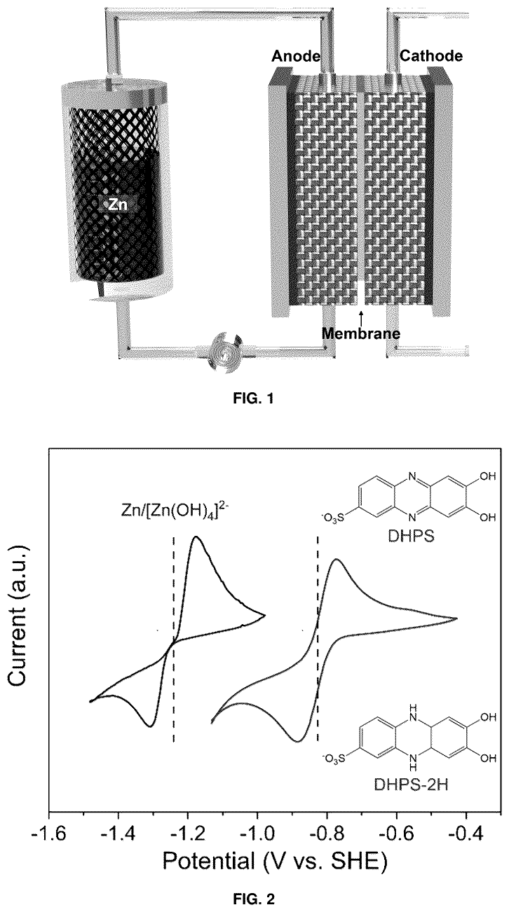

The setup comprises a RM-ZAFC as shown in FIG. 1. Zn metal is liberated from the anode compartment to an external storage tank with easy access. The reaction of Zn could then be accomplished by a redox targeting process with a redox mediator DHPS.

In the RM-ZAFC, graphite felt (6 mm in thickness, SGL Carbon) was used for both positive and negative electrodes. Carbon felt were thermally treated at 400° C. in air for 16 hours. Sustainion X37-50 membrane was used to separate the catholyte and anolyte, and the membranes were soaked in 3 M NaOH overnight prior to use. Viton gasket and PTFE tubing (ColeParmer) were employed to build the cell. 0.4 M DHPS/3 M NaOH (loaded with Zn granules) as anolyte was circulated by peristaltic pump with a flow rate of 50 mL/min. O₂ was bubbled into the cathode and N₂ was bubbled into the anolyte continuously with a flow rate of 0.5 L/min during the tests.

### Results and Discussion

FIG. 2 shows the CV of 20 mM DHPS and 20 mM [Zn(OH)₄]²⁻ in 3 M NaOH. The potential of DHPS/DHPS-2H is around 414 mV higher than Zn/[Zn(OH)₄]²⁻, indicating that DHPS could oxidize Zn metal. Upon discharging, DHPS-2H is firstly oxidized to DHPS on the anode and circulated into anodic tank, where it is regenerated by oxidizing Zn to [Zn(OH)₄]²⁻ first. When the concentration of [Zn(OH)₄]²⁻ reaches the solubility limit, it will transform into solid ZnO suspension, which may flow into the anode compartment and may cause clogging after long-term discharging.

### Example 3. Cartridge Loaded With Zn Granules

To address the problem mentioned in Example 2, Zn granules consisting of 90 wt. % Zn powder, 5 wt. % carbon black, and 5 wt. % PVDF were prepared to contain the reaction of Zn and consequently the discharge product, with which the formed [Zn(OH)₄]²⁻ is transformed into ZnO on the surface of the granules. As shown in FIG. 3, a cartridge loaded with Zn granules is placed in the anodic tank. After Zn was depleted, the cartridge can be easily removed and replaced with fresh Zn granules to continually generate electricity.

### Example 4. RM-ZAFC Single Cell With 0.2 M Co(III)TiPA/3 M NaOH

A RM-ZAFC single cell with 0.2 M Co(III)TiPA/3 M NaOH (with continuous O₂ bubbling) as catholyte and 0.4 M DHPS/3 M NaOH as anolyte was assembled. The cartridge loaded with Zn granules (prepared in Example 3) was changed 3 times during the entire discharge process.

### Flow Cell Assembly and Test

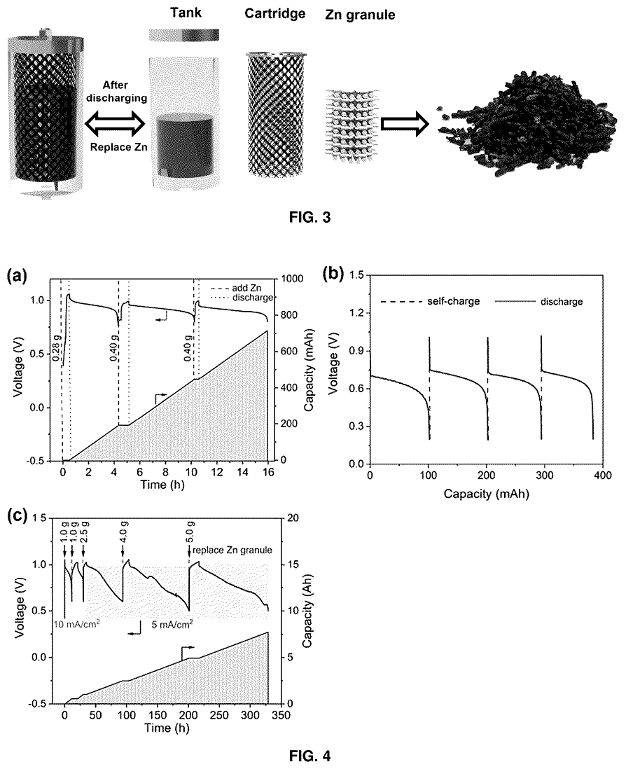

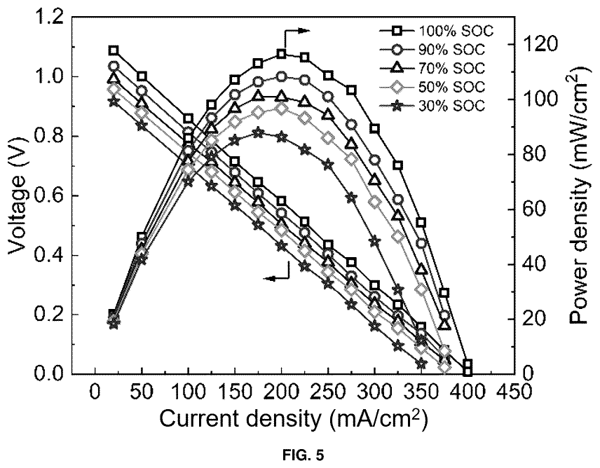

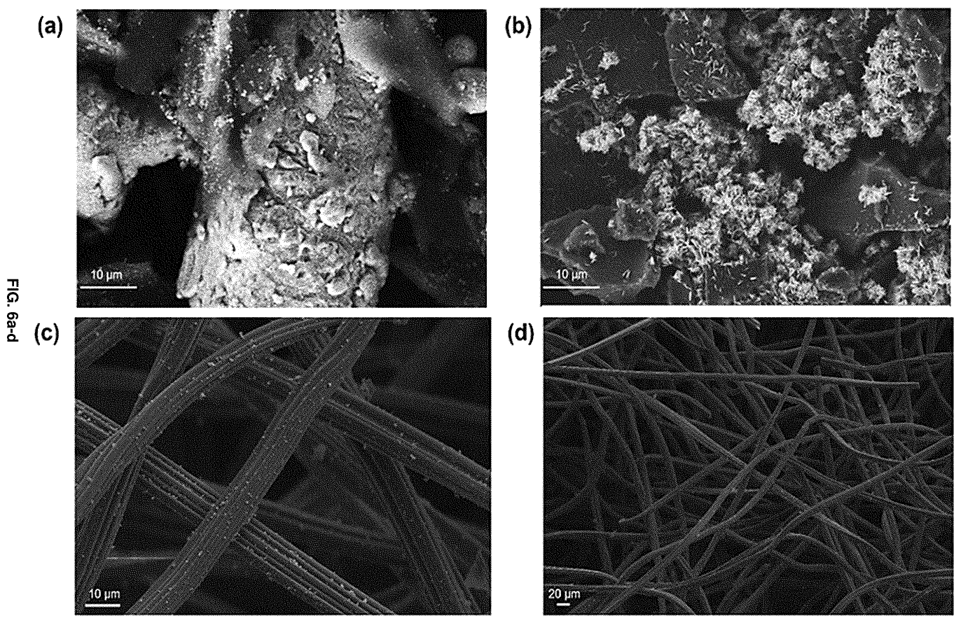

For the RM-ZAFC for long-term operation in FIG. 4, the active area was 5 cm² and graphite felt (6 mm in thickness, SGL Carbon) was used for both positive and negative electrodes. For the RM-ZAFC for power test in FIG. 5, 4 pieces of 1 cm² Toray carbon papers were used as the electrodes for both sides. Carbon felt and carbon paper were thermally treated at 400° C. in air for 16 hours. Sustainion X37-50 membrane was used to separate the catholyte and anolyte, and the membranes were soaked in 3 M NaOH overnight prior to use. Viton gasket and PTFE tubing (ColeParmer) were employed to build the cell. Both the catholyte and anolyte were circulated by peristaltic pumps with a flow rate of 50 mL/min. O₂ was bubbled into the catholyte and N₂ was bubbled into the anolyte continuously with a flow rate of 0.5 L/min during the tests. The cell performance was tested and recorded by Arbin battery tester. For the tests at 100 mA/cm², the cell was rested for self-charging of catholyte after each discharging process. O₂ was bubbled continuously during both discharging and self-charging.

### Results and Discussion

Every time when the Zn granules were replaced in the anodic tank, the voltage increased rapidly at first, and then the battery can be discharged at >0.9 V at 10 mA/cm² until all the Zn was depleted (FIG. 4a). The overall Zn utilization can reach 90%. In addition, the cell can be discharged steadily at 100 mA/cm² (FIG. 4b) with a discharge voltage as high as >0.7 V. This cell also showed excellent stability for long-term operation, as shown in FIG. 4c. It is worth noting that with multiple replenishment of zinc, the self-charging process slowed down gradually (the voltage recovery became slower) as a result of concentration increase of [Zn(OH)₄]²⁻, limiting Zn oxidation process, and stabilized when it reached saturation. In FIG. 4c, the cell was discharged to a capacity of more than 8 Ah, while the solubility of [Zn(OH)₄]²⁻ in 3 M NaOH is less than 0.25 M, corresponding to ˜3 Ah in 250 mL anolyte. FIG. 5 shows the power performance of the cell. The maximum power density can reach ˜118 mW/cm².

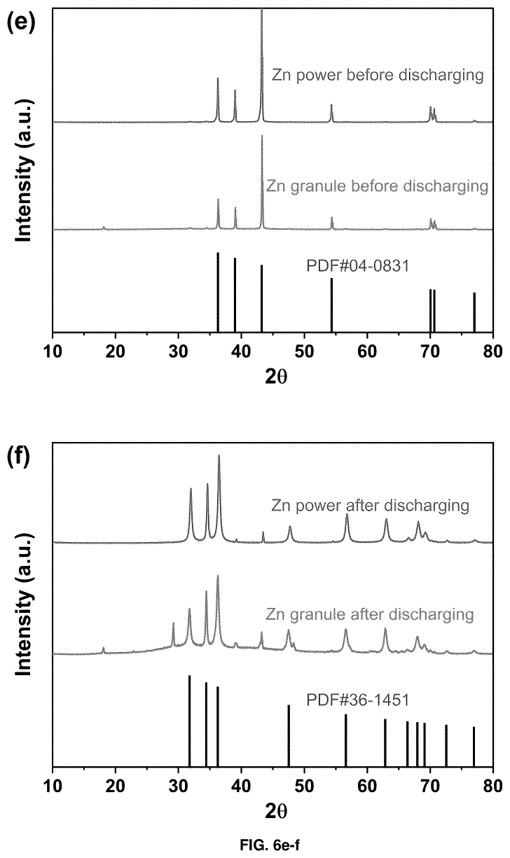

FIGS. 6a-b show the SEM images of the Zn granules and Zn powder before and after discharging. The shape of zinc particles changed from round shape to needle-like after discharging. As shown in FIGS. 6e-f, XRD pattern of Zn granules changed from Zn (PDF #04-0831) to ZnO (PDF #36-1451). We also compared the XRD patterns and SEM images of carbon felt electrode used in the anode compartment before and after discharging (FIGS. 6c-f). Nearly no ZnO was deposited on the carbon felt after discharging, which indicates the discharge product ZnO is solely formed on the surface of Zn granules. In this way, it addresses the electrode passivation issue confronted by conventional alkaline Zn-based batteries and enables a facile “refueling” of Zn metal in the tank.

### Example 5. 4-Cell ZAFC Stack

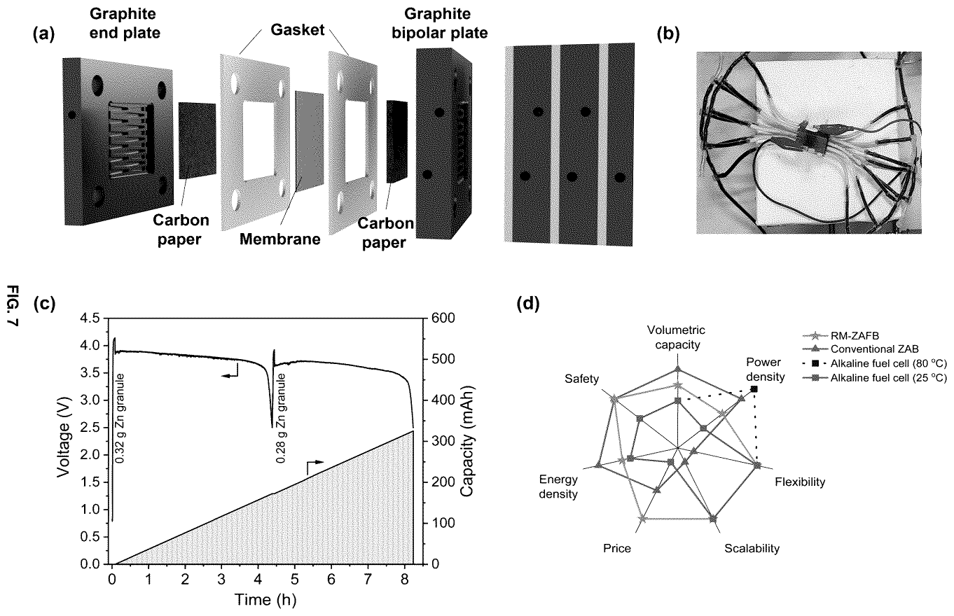

Another advantage of RM-ZAFC is its good scalability. We assembled a 4-cell ZAFC stack employing 0.2 M Co(III)TiPA/3 M NaOH as catholyte with continuous O₂ bubbling and 0.4 M DHPS/3 M NaOH as anolyte loaded with Zn granules in the anodic tank (FIGS. 7a-b). As shown in FIG. 7a, there is a configuration depicting the exploded view of a 4-cell RM-ZAFC stack. The configuration 700 includes a graphite end plate 701, carbon paper 702, a membrane 703, gasket 704, and a graphite bipolar plate 705.

4-cell ZAFC Stack Assembly and Test

For the 4-cell ZAFC stack in FIG. 7, 4 pieces of 1 cm² Toray carbon papers were used as the electrodes for both sides of each cell. Carbon paper were thermally treated at 400° C. in air for 16 hours. Sustainion X37-50 membrane was used to separate the catholyte and anolyte, and the membranes were soaked in 3 M NaOH overnight prior to use. The cell performance was tested and recorded by Arbin battery tester.

### Theoretical Volumetric Capacity

Calculation of volumetric capacity of anodic side of RM-ZAFB:

C=C_{Zn}·U·a·p+C_{DHPS}·(1−p)

where C_{Zn} (5,854 Ah/L) is the volumetric capacity of Zn metal, U (90%) is the utilization of Zn, a (69 vol. %) is the volumetric content of Zn in granules (calculated based on the density of Zn (7.14 g/cm³), carbon black (1.7 g/cm³), and PVDF (1.78 g/cm³)), p (50%) is the volume ratio of solid granules, C_{DHPS} (96 Ah/L) is the volumetric capacity of 1.8 M DHPS. C was calculated to be 1,866 Ah/L.

### Results and Discussion

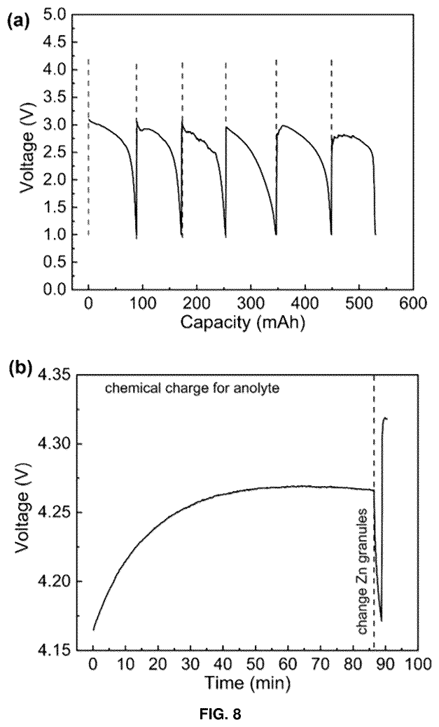

This stack can be discharged at a voltage of >3.8 V at 10 mA/cm2 (FIG. 7c). After that, we increased the current density to 100 mA/cm², and the cell can still operate at a voltage of around 3 V (FIG. 8). As summarized in FIG. 7d, the RM-ZAFC has the advantages of operation flexibility and scalability as fuel cells and flow batteries, which makes it suitable for various applications compared with the conventional ZABs. In addition, neither expensive electrocatalysts for oxygen reduction reaction (ORR) and hydrogen oxidation reaction nor gas diffusion layer on the air electrode is required, which could greatly reduce the cost. The theoretical volumetric capacity of this system could reach 1,866 Ah/L, considerably higher than the commercial high-pressure H₂ tank (35 MPa: 639 Ah/L; 70 MPa: 1,278 Ah/L). Thus, the theoretical energy density of this system (˜1,900 Wh/L) is superior to alkaline fuel cells. Moreover, Zn is much safer than H₂ for operation, storage, and transportation. Although alkaline fuel cell can achieve higher power density at 80° C., its power density is considerably suppressed at room temperature, which is even much lower than RM-ZAFC.

### Example 6. RM-ZAFC With a Gas Diffusion Air Electrode as Cathode

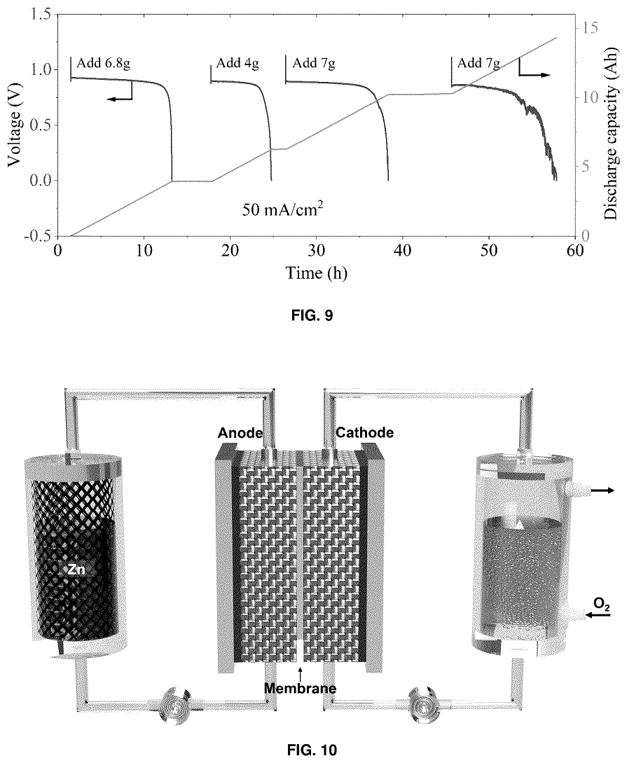

Gas diffusion air electrode can also serve as the cathode in RM-ZAFC. We assembled a ZAFC employing Pt/C coated carbon paper as cathode supplied with dry and 0.5 M DHPS and 6 M KOH as anolyte loaded with Zn granules in the anodic tank (FIG. 9).

### ZAFC With a Gas Diffusion Air Electrode as Cathode Assembly and Test

A flow cell (Scribner, with an active area of 6.7 cm2) was assembled with FAAM-15 membrane to measure the power density at different conditions. The anolyte used was 0.5 M DHPS and 6 M KOH, with an anode flow rate of 20 mL/min, cathode pressure of 1.5 bar, and a working temperature of 40° C., unless otherwise stated. Two thermoelectric peltier cooler modules (Multicomp Pro MPADV-127-140160-S) were employed to heat the battery, and a TYPE-K THERMOCOUPLE PROBE temperature sensor was sandwiched between the cathode electrode and membrane to track the battery temperature in real time. The anode electrode was composed of three layers of SGL 29 AA carbon paper that had undergone a pre-treatment at 400° C. for 16 hours to enhance its hydrophilicity. The cathode electrode was a catalyst-coated SGL 38 BB carbon paper with a Pt loading of 0.4 mg/cm2. To prepare the cathode electrode, poly (fluorenyl-co-biphenyl N,N-dimethyl piperidinium) (PFBP14, the fluorine ratio is 14%) copolymers were firstly dissolved in Dimethyl sulfoxide (DMSO) and filtered with 0.45 μm PTFE filter to form a 5% ionomer solution. Subsequently, Pt/C (38.7 wt % Pt, Tanaka, Japan) was added into the ionomer solution and nafion solution with a composition of AEIs:total carbon:Pt=1:2:1.33 based on a Pt loading of 0.4 mg/cm2. The prepared slurry was then dispersed in an isopropanol (IPA)/deionized (DI) water (10 to 1) solution with a solid/liquid ratio of 5 wt %. After 1 hour of ultrasonic treatment, the prepared ink was sprayed onto the hydrophobic surface of SGL 36 BB carbon paper, which was then heat-treated at 140° C. for 12 h to evaporate the DMSO and served as the cathode electrode.

ZAFC was operated at 50° C. The cathode was supplied with dry oxygen at a pressure of 1.5 bar and periodically purged every 10 seconds to prevent water flooding. To avoid electrode clogging form Zn granules or the generated ZnO, two pieces of carbon felt were installed at the outlet of the tank and were replaced whenever new granules were added.

### Results and Discussion

FIG. 9 presents the discharge curves of the RM-ZAFC at 50 mA/cm². New Zn granules were added to the tank after the voltage dropped to the cutoff level of 0 V. It can be observed that this RM-ZAFC can operate steadily. It delivered a high capacity of 14.31 Ah with an overall Zn utilization is 78.2%. The lost capacity can be attributed by three factors: the IR drop, crossover issue caused by the high-pressure oxygen and the oxidation of Zn in the air condition.

1. A redox-mediated metal-air fuel cell system, comprising:
a redox flow cell comprising:
a cathode compartment, comprising one of:
a cathode electrode, and an inlet and outlet suitable for bubbling gas through the cathode compartment;
or a gas diffusion air electrode for oxygen reduction reaction (ORR) supplied with air through the cathode compartment;
an anode compartment, comprising an anode electrode, and an inlet and outlet suitable for receiving and providing an anolyte to a first tank;
an ion-selective membrane between the cathode compartment and the anode compartment; and
a first tank suitable to house an anolyte and a redox-mediated metal-air fuel cell cartridge and an inlet and outlet suitable for receiving and providing an anolyte to the anode compartment,
wherein:
the redox-mediated metal-air fuel cell cartridge, comprises:
a cartridge housing; and
a composite material, comprising:
a metal selected from an alkali metal, an alkaline earth metal, aluminium, zinc, or iron;
a conductive carbon material; and
a binder.

2. The system according to claim 1, wherein the metal is selected from one or more of the group selected from Zn, Li, Na, K, Mg, Ca, Al, and Fe.

3. (canceled)

4. The system according to claim 1, wherein the binder is selected from one or more of ethylene cellulose, polyolefin, and a fluorine-containing thermoplastic.

5. The system according to claim 4, wherein the binder is PVDF.

6. The system according to claim 1, wherein:
the metal is present in an amount of from 50 to 95 wt %;
the conductive carbon material is present in an amount of from 2.5 to 30 wt %;
the binder is present in an amount of from 2.5 to 20 wt %.

7. (canceled)

8. (canceled)

9. (canceled)

10. The system according to claim 1, wherein the anode compartment and the first tank further comprise an anolyte comprising an anodic redox mediator and an electrolyte.

11. The system according to claim 10, wherein on or more of the following apply:
(a) the anodic redox mediator is selected from one or more of the group consisting of a phenazine derivative, an anthraquinone derivative, and an alloxazine derivative;
(b) the anodic redox mediator has a concentration of from 0.01 to 2 M; and
(c) the electrolyte is selected from one or more of aqueous NaOH, and aqueous.

12. The system according to claim 10, wherein when the cathode compartment comprises a cathode electrode, and an inlet and outlet suitable for bubbling gas through the cathode compartment, it further comprises a catholyte comprising a cathodic redox mediator and an electrolyte.

13. (canceled)

14. (canceled)

15. The system according claim 1, wherein, when the cathode compartment comprises a gas diffusion electrode, then the cathodic air electrode is selected from a porous carbon material that is coated with an oxygen reduction reaction catalyst.

16. A redox-mediated metal-air fuel cell cartridge, comprising:
a cartridge housing; and
a composite material, comprising:
a metal selected from an alkali metal, an alkaline earth metal, aluminium, zinc, or iron;
a conductive carbon material; and
a binder.

17. (canceled)

18. (canceled)

19. The cartridge according to claim 16, wherein the binder is selected from one or more of ethylene cellulose, polyolefin, and a fluorine-containing thermoplastic, optionally wherein the fluorine-containing thermoplastic is selected from one or more of the group selected from PTFE and PVDF.

20. The cartridge according to claim 19, wherein the binder is PVDF.

21. The cartridge according to claim 16, wherein:
the metal is present in an amount of from 50 to 95 wt %;
the conductive carbon material is present in an amount of from 2.5 to 30 wt %;
the binder is present in an amount of from 2.5 to 20 wt %.

22. (canceled)

23. The cartridge according to claim 16, wherein the metal source material is provided in particulate form.

24. (canceled)

25. A method of feeding a metal in a redox-mediated metal-air fuel cell system, comprising:
a redox flow cell comprising:
a cathode compartment, comprising one of:
a cathode electrode, and an inlet and outlet suitable for bubbling gas through the cathode compartment;
an anode compartment, comprising an anode electrode, an anolyte comprising an anodic redox mediator and an electrolyte, and an inlet and outlet suitable for receiving and providing the anolyte to a first tank;
an ion-selective membrane between the cathode compartment and the anode compartment; and
a first tank comprising the anolyte, a redox-mediated metal-air fuel cell cartridge as described in claim 16 and an inlet and outlet suitable for receiving and providing the anolyte to the anode compartment, wherein the method involves:
(a) cycling the anolyte from the first tank to the anode compartment and back again, and supplying a gas to the catholyte; and
(b) replacing the redox-mediated metal-air fuel cell cartridge when it has been exhausted.

26. The method according to claim 25, wherein one or more of the following apply:
(a) when the cathode compartment comprises a cathode electrode, and an inlet and outlet suitable for bubbling gas through the cathode compartment, the cathodic redox mediator is selected from one or more of the group consisting of Co (III) TiPA, cobalt triethanolamine complex [Co(TEA)] and anthraquinone-2,6-disulfonate (AQDS);
(b) when the cathode compartment comprises a cathode electrode, and an inlet and outlet suitable for bubbling gas through the cathode compartment, the cathodic redox mediator has a concentration of from 0.01 to 1 M;
(c) the anodic redox mediator is selected from one or more of the group consisting of a phenazine derivative, an anthraquinone derivative, and an alloxazine derivative;
(d) the anodic redox mediator has a concentration of from 0.01 to 2 M; and
(e) the electrolyte is selected from one or more of aqueous NaOH, aqueous KOH, and aqueous LiOH, optionally wherein the concentration of the NaOH in water is 3 M.

27. The method according to claim 25, wherein when the cathode compartment comprises a cathode electrode, and an inlet and outlet suitable for bubbling gas through the cathode compartment, the cathode compartment comprises:
a cathode housing section;
a cathode housed within the cathode housing section; and
a second tank suitable to house a catholyte, an inlet and outlet suitable for receiving and providing a catholyte to the cathode housing section, and an inlet and outlet suitable for bubbling gas through the second tank.

28. The method according to claim 25, wherein one or more of the following apply:
(a) when the cathode compartment comprises a gas diffusion electrode for oxygen reduction reaction supplied with air or oxygen directly through the cathode compartment, the cathodic air electrode is selected from a porous carbon material that is coated with an oxygen reduction reaction catalyst;
(b) the anodic redox mediator is selected from one or more of the group consisting of a phenazine derivative, an anthraquinone derivative, and an alloxazine derivative;
(c) the anodic redox mediator has a concentration of from 0.01 to 2 M; and
(d) the electrolyte is selected from one or more of aqueous NaOH, aqueous KOH, and aqueous LiOH.

29. A metal-air fuel cell metal source material, wherein the source material comprises:
a metal selected from an alkali metal, an alkaline earth metal, aluminium, zinc, or iron;
a conductive carbon material; and
a binder.

30. A composite material, comprising:
a metal selected from an alkali metal, an alkaline earth metal, aluminium, zinc, or iron;
a conductive carbon material; and
a binder.

31. (canceled)

32. (canceled)

33. (canceled)

34. (canceled)

35. (canceled)

36. (canceled)

37. (canceled)

38. (canceled)
